(19) United States
(12) Patent Application Publication
(10) Pub. No.: US 2021/0295364 A1
(43) Pub. Date: Sep. 23, 2021

(54) METHOD FOR CONSTRUCTING PROMOTIONAL OFFERS RESPONSIVE TO PURCHASE INTENT OF A CONSUMER

(71) Applicant: Greyfox Labs, Inc., Bellevue, WA (US)

(72) Inventor: Arun Veettil, Bellevue, WA (US)

(21) Appl. No.: 17/182,158

(22) Filed: Feb. 22, 2021

Related U.S. Application Data
(60) Provisional application No. 62/993,566, filed on Mar. 23, 2020.

(51) Int. Cl. G06Q 30/02

(52) U.S. Cl. CPC G06Q 30/0211; G06Q 30/0224; G06Q 30/0222; G06Q 30/0282; G06Q 30/0201

(57) ABSTRACT

One variation of a method for generating reward packages includes: in response to receiving selection of a primary product, in a set of products offered by a merchant, at a computing device associated with a user, populating a basket with the primary product; estimating a first intent score for the user for purchase of a first secondary product, in the set of products, based on the primary product and historical purchases of products at the merchant; calculating a first reward value predicted to increase the first intent score toward a target intent score; and, in response to the first minimum reward value falling below a maximum reward value, selecting a first reward for pairing with purchase of the first secondary product based on the first reward value and serving a first reward package, including the first secondary product paired with the first reward, to the user at the computing device.

### CROSS-REFERENCE TO RELATED APPLICATIONS

This Application claims the benefit of U.S. Provisional Application No. 62/993,566, filed on 23 Mar. 2020, which is incorporated in its entirety by this reference.

### TECHNICAL FIELD

This invention relates generally to the field of digital commerce and more specifically to new and useful systems and methods for generating consumer-specific promotional offers responsive to indicated purchase intents in the field of digital commerce.

### BRIEF DESCRIPTION OF THE FIGURES

FIG. 1 is a flowchart representation of a method;

FIG. 2 is a flowchart representation of the method;

FIG. 3 is a flowchart representation of the method;

FIG. 4 is a flowchart representation of the method;

FIG. 5 is a flowchart representation of the method; and

FIG. 6 is a flowchart representation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

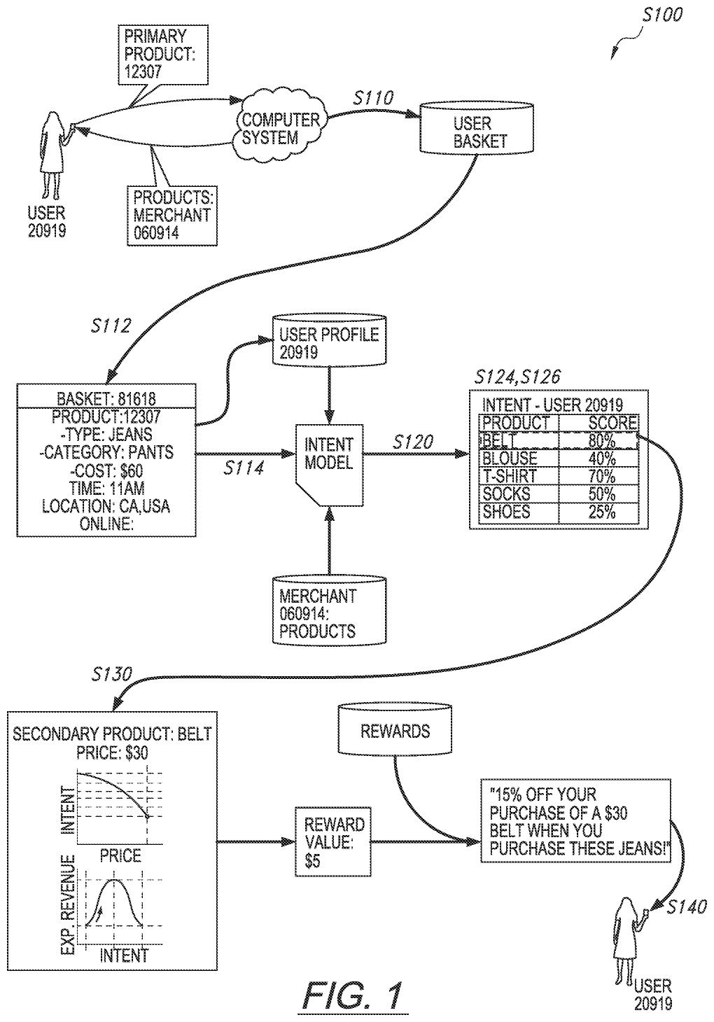

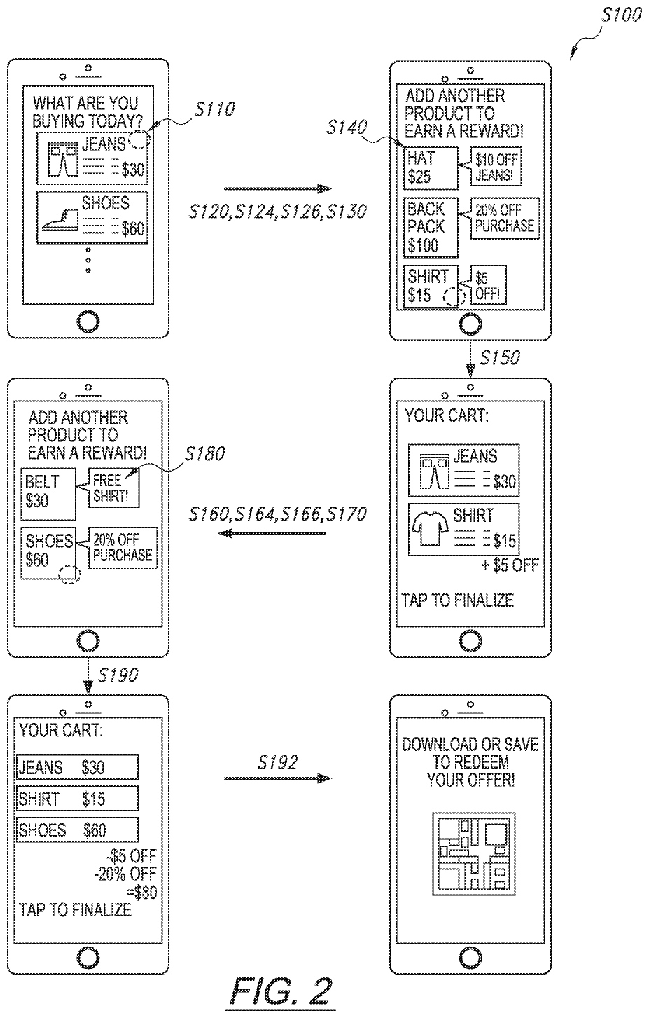

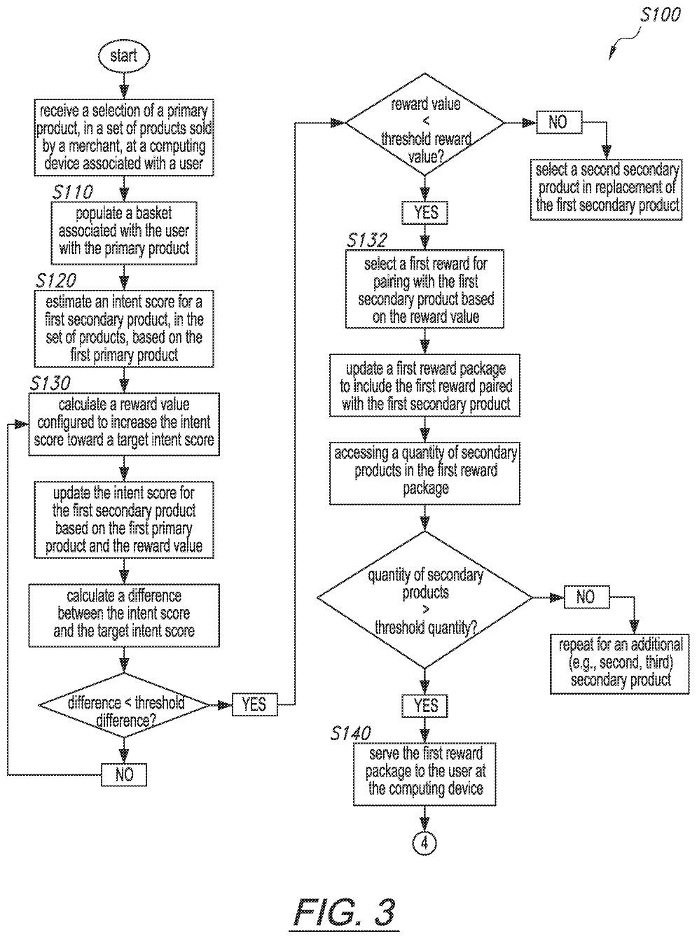

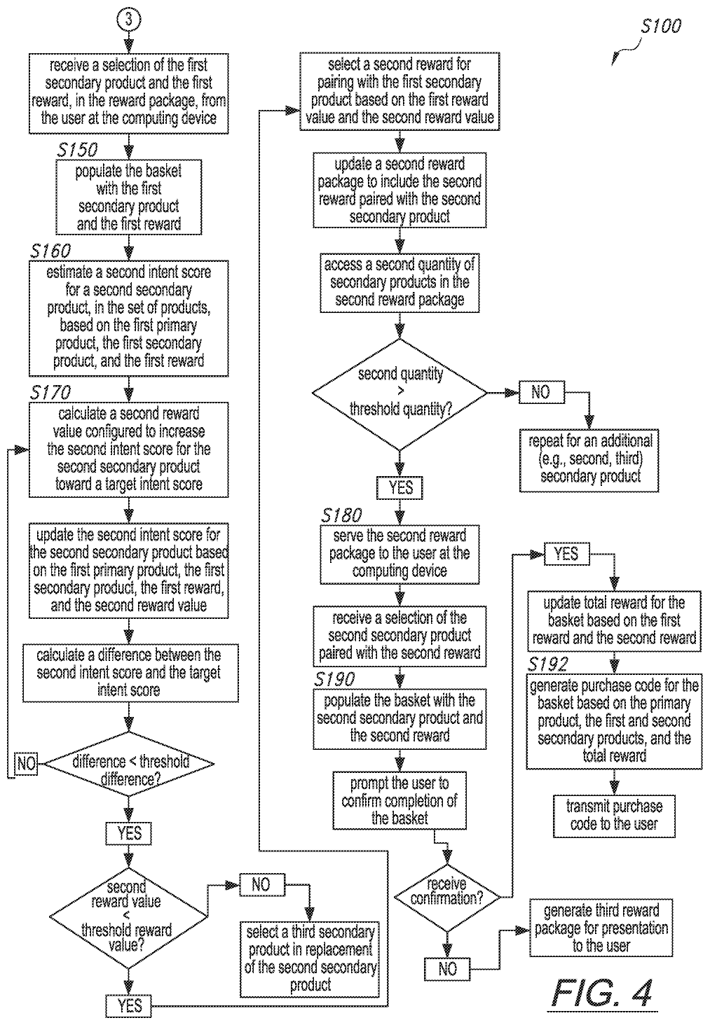

As shown in FIGS. 1-6, a method S100 includes: in response to receiving selection of a primary product at a computing device associated with a first user, the primary product in a set of products offered by a merchant, populating a basket associated with the first user with the primary product in Block S110 (e.g., by a product selection module); estimating a first predicted intent score for the user for purchase of a first secondary product, in the set of products, based on the primary product and historical purchases of products at the merchant in Block S120 (e.g., by an intent prediction module); and calculating a first minimum reward value predicted to increase the first predicted intent score to greater than a threshold intent score in Block S130 (e.g., by a reward selection module). The method S100 further includes, in response to the first minimum reward value falling below a maximum reward value: selecting a first reward for pairing with purchase of the first secondary product based on the first minimum reward value in Block S132 (e.g., by a reward package generation module); and serving a first reward package to the first user at the computing device, the first reward package including the first secondary product paired with the first reward in Block S140 (e.g., by a reward package delivery module).

In one variation shown in FIGS. 1-6, the method S100 includes: in response to receiving selection of a primary product at a computing device associated with a user, the primary product in a set of products offered by a merchant, populating a basket associated with the user with the primary product in Block S110; extracting a first set of basket characteristics for the basket comprising a product type of the primary product and a first value assigned to the primary product in Block S112; accessing an intent model linking basket characteristics with purchases of products at the merchant in Block S114; and characterizing a first predicted intent of the user for selection of a first secondary product, in the set of products, based on the set of basket characteristics and the intent model in Block S120. In this variation, the method S100 further includes, in response to the first predicted intent exceeding a threshold intent: calculating a first reward for pairing with the first secondary product based on the first predicted intent of the user for the first secondary product in Block S130; serving a first reward package to the first user at the computing device, the first reward package comprising the first secondary product paired with the first reward in Block S140; and, in response to receiving selection of the first secondary product from the user, at the computing device, populating the basket with the first secondary product paired with the first reward in Block S150.

In one variation shown in FIGS. 1-6, the method S100 includes: populating a basket with a primary product in response to receiving selection of the primary product, from a digital catalog of products offered by a merchant, by a user at a computing device in Block S110; calculating a first set of intent scores for purchase of secondary products, in a first set of products offered by the merchant, by the user based on the primary product and purchase history of customers at the merchant in Block S120; calculating a first set of expected revenues associated with the first set of products based on the set of intent scores and prices of products in the first set of products in Block S124; selecting a first subset of secondary products in the first set of products based on the first set of expected revenues in Block S126; calculating a reward corresponding to the secondary product based on an expected revenue associated with the secondary product in Block S130, for each secondary product in the first subset of secondary products; and presenting the first subset of secondary products and corresponding rewards to the user via the computing device in Block S140.

In one variation, the method S100 further includes: adding the first secondary product and the first reward to the basket in response to receiving selection of the first secondary product, from the first reward package, by the user at the computing device in Block S150; calculating a second set of intent scores for purchase of products, in a second set of products offered by the merchant, by the user based on the primary product, the first secondary product, and purchase history of customers at the merchant in Block S160; calculating a second set of expected revenues for the second set of products based on the second set of intent scores in Block S164; selecting a second subset of products in the second set of products based on the second set of expected revenues in Block S166; calculating a reward corresponding to the product based on a second expected revenue associated with the product and the first reward in Block S170, for each product in the second subset of products; presenting the second subset of products and corresponding rewards to the user via the computing device in Block S180; adding the second product and the second reward to the basket in Block S190, in response to receiving selection of a second product, in the second subset of products, by the user at the computing device; and generating a purchase code pairing the first reward and the second reward with purchase of the primary product, the first product, and the second product in Block S192.

### 2. Applications

Generally, the method S100 can be executed by a computer system (e.g., a remote computer system, a computer network, a remote server) in conjunction with a consumer-facing platform and/or application (e.g., native application or web application) in order to: characterize a user's purchase intent for a particular transaction at a merchant; and create a custom promotional offer based on the user's purchase intent that includes discounts and/or rewards associated with particular products of interest to the user while increasing revenue for the merchant.

While merchants frequently offer promotional discounts and/or rewards on particular products, these offers are based on the merchant's understanding of how a general population of consumers may respond and do not account for product preferences, price sensitivities, and purchase habits of individual customers. Accordingly, any given consumer is unlikely to convert these offers—even offers of significant value—unless these offers align with the consumer's purchase intent for her current transaction. Therefore, the computer system can execute Blocks of the method S100 in order to: identify a primary product that the user intends to purchase from a set of available products offered by a merchant; access and analyze historical sales data and user demographic data to identify additional products offered by the merchant that may be of interest to the user given the user's specific purchase intent; pair the purchase of these additional products with rewards and/or discounts to products indicated by the user's purchase intent; receive selections of additional products and corresponding rewards from the user; and generate a promotional offer on the primary product and additional products selected by the user that includes these rewards. The computer system can therefore filter a large set of products (e.g., 100 products, 1000 products) sold by a particular merchant into a unique offer that yields both discounts on particular products of interest indicated by the user and increased revenue generated by the merchant through sale of additional products.

The method S100 is described below as executed by a computer system, such as including a set of modules (e.g., a product selection module, an intent prediction module, a reward selection module, a reward package generation module, and/or a reward package delivery module) executing on a server, a local computer network, and/or a distributed computer network.

### 3. Example: UX

The computer system facilitates instances of a gamified, dynamic offer generation process for a set of products offered by a particular merchant (e.g., a clothing store) according to user preferences and selections. Generally, the user initiates the offer generation process by indicating a primary product or a type of primary product that she intends to purchase from the merchant. For example, the computer system can display a selection interface including a catalog of products offered by the merchant (e.g., a scrollable menu within an application on a mobile device, an online catalog displayed by web browser), from which the user can select a particular primary product (e.g., a pair of women's jeans) to indicate her purchase intent. The platform can then identify secondary products (e.g., a subset of three products) offered by the merchant that the user may have a high probability of purchasing—given her selected primary product—and display a picture, description, and pricing information for each secondary product at a second user interface. For example, if the user selects women's jeans as a primary product, the platform may identify a subset of other products that are frequently bought with jeans or that may be particularly appealing to that user—such as a belt, a pair of shoes, and a tee-shirt—and display information about these products to the user at the second user interface.

Concurrently, the computer system can also calculate and display, at the second user interface, rewards corresponding to each secondary product and redeemable upon purchase of the primary product and a particular secondary product. For example, the platform may allow the user to choose between: a thirty percent discount on her selected pair of jeans with purchase of the suggested belt, a twenty percent discount on her basket (e.g., a virtual shopping basket) of products with purchase of the suggested pair of shoes, or a second, free tee-shirt with purchase of the suggested tee-shirt. Upon receiving the user's selection of a secondary product and a reward associated with purchase of the secondary product, the platform may display a third user interface including a basket (e.g., cart) containing the two items and a price of the basket (e.g., accounting for the selected reward). For example, if the user selects the suggested pair of shoes as the second product, the computer system can transition to display of the third user interface including: a basket of the pair of jeans (e.g., the primary product); suggested pair of shoes; and the user's reward (e.g., a twenty percent discount).

For example, after receiving a user's selection of a secondary product (e.g., shoes) and the reward associated with the secondary product (e.g., 20% discount), the computer system can: update and/or or recalculate probabilities that the user will purchase additional, tertiary products offered by the merchant based on the selected secondary product; select a subset of tertiary products based on these probabilities; select rewards associated with each tertiary product in the second subset of products; and display a fourth user interface including an image, a description, and a price of each tertiary product and a reward associated with purchase of the tertiary product. For example, the computer system can display the fourth user interface representing options to purchase a handbag (e.g., paired with an additional twenty percent discount for the selected pair of jeans), a pair of sunglasses (e.g., paired with an additional ten percent discount for the total basket price), and a hat (e.g., paired with a free tee-shirt). For certain types of merchants (e.g., a clothing store), the computer system may repeat this process until a certain number of products are selected for purchase, a certain number of steps (e.g., moves) in the offer generation process are executed, or until the basket size (e.g., price of the basket) reaches a certain threshold value.

For example, upon receiving an input indicating selection of a tertiary product and a reward associated with the selected tertiary product, the computer system can display a fifth user interface including representations of each product in the basket (e.g., the pair of jeans, the pair of shoes, and the handbag selected by the user), the rewards associated with purchase of the secondary and tertiary product (e.g., itemized rewards, an indication of total savings over undiscounted purchases of the basket items), and a confirm affordance indicating an option to finalize the offer including the displayed products and the displayed rewards.

Upon receiving a user input on the confirm affordance, the computer system can display a completion interface that includes a purchase code redeemable at the merchant for rewards related to purchase of the particular products selected by the user during the offer generation process. For example, the completion interface may include a promotional code that can be entered or copied into a corresponding field during digital checkout at an online retailer in order to apply the rewards to a purchase of the selected products. In another example, the completion interface may include a barcode that can be downloaded and/or saved within an offer generation application and/or an application associated with the merchant and scanned during checkout at the merchant's retail location.

### 4. Merchant Onboarding

The computer system can generate a product database for the merchant based on product information supplied by the merchant. Once this product database is generated for the merchant, the user may access the product database to view and/or select products and rewards.

In one implementation, the computer system can integrate with a digital sales platform (e.g., e-commerce platform) employed by the merchant in order to access and/or store descriptions, indicators, and prices for each product sold by the merchant. The computer system can also access historical sales data that includes purchase frequency (e.g., popularity) of each product, combinations of products that have been purchased concurrently, and total basket sizes (e.g., total prices across all products purchased) for each transaction.

In another implementation, the computer system can import product descriptions and historical sales data from a cloud platform employed by the merchant. For example, the computer system can import and parse a file (e.g., a CSV file) imported from the merchant's cloud sales and/or analytics platform in order to access: a list of descriptions, prices, popularities, and margins associated with each product offered by the merchant; and/or sales data indicating products sold during each purchase, total prices of these transactions, and available demographic information (e.g., age, gender, location) of customers associated with these purchases.

In another implementation, the computer system can host or interface with a merchant portal (e.g., via native application or web application)—executing on a computing device (e.g., a mobile device, a computer) accessed by the merchant (e.g., a manager employed by the merchant)—to configure a merchant profile for the merchant. For example, the computer system can prompt the merchant to upload: a set of products available for sale by the merchant; descriptions for each product in the set of products; a price of each product in the set of products; historical sales data for each product and/or combinations of products; available demographic information (e.g., age, gender, location) of customers associated with purchases of these products; etc. The computer system can then configure a product database for the merchant—accessible to users (e.g., via instances of a user portal)—based on this information supplied by the merchant.

### 4.1 Merchant Settings

In one variation, the computer system can also prompt the merchant to provide a set of merchant settings for selecting secondary products and rewards, such as: a maximum reward value for a particular product; a first subset of products, in the set of products, ineligible for pairing with rewards; a second subset of products, in the set of products, the merchant wishes to serve to users more frequently; a set of goals (e.g., increase quantity of products selected, increase average value of baskets); etc. The computer system can enable the merchant to access the user portal at any time to adjust these merchant settings, modify products available in the product database, and/or update sales data.

In one implementation, the computer system can prompt the merchant to input future sales and/or pricing data to better inform current dynamic pricing. For example, for a winter coat sold by the merchant, the computer system can prompt the merchant to input: a period of time during which sales of the winter coat are expected to increase (e.g., a period of high-demand); a period of time during which sales of the winter coat are expected to decrease (e.g., a period of low-demand); a future date at which a price of the winter coat will be reduced; the price of the winter coat at the future date; and/or a future date at which the winter coat will no longer be available for purchase. The computer system can then leverage this information when selecting rewards for pairing with the winter jacket. For example, in response to identifying the price of the winter jacket will be reduced by 50% by an end of the week, the computer system can generate a reward for the winter jacket corresponding to 25% off, thereby increasing a likelihood of purchase of the winter coat prior to the upcoming reduction in the price.

Thus, the computer system can generate a product database for a particular merchant based on product information supplied by the merchant. The computer system can then leverage historical sales data supplied by the merchant to enable dynamic offer generation for products available within the product database in accordance with both user preferences and business needs of the merchant.

### 5. Basket Initialization

Block S110 of the method S100 recites: in response to receiving selection of a primary product, from a set of products offered by a merchant, at a computing device associated with a user, populating a basket associated with the user with the primary product. In particular, the user may initiate selection (e.g., via the user portal) of a particular merchant, in a set of merchants, from which the user wishes to shop and select a primary product from the set of products offered by this particular merchant. In response to receiving selection of this primary product, the computer system can initialize a basket (e.g., a virtual shopping cart) for the user—including the selected primary product—in Block S110 and continue to update the basket as the user selects additional products to add to her basket.

Generally, the computer system: displays a user interface including a navigable catalog of products offered by the merchant; prompts the user to initiate the dynamic offer generation process; receives selection of a primary product from the catalog of products; and associates the primary product with a purchase intent of the user. For example, the user can open a mobile application and/or web application associated with the dynamic offer generation platform to access an instance of a user portal (i.e., user interface) including a navigable menu of products (e.g., images, descriptions, and prices of products) offered by the merchant. The computer system then displays a banner and/or notification prompting the user to initiate the dynamic offer generation by indicating a purchase intent (e.g., a product or set of products that the user intends to purchase during the current transaction). In response to receiving a user selection of a primary product (e.g., a pair of jeans) indicating a particular purchase intent for the transaction, the computer system can display an affordance prompting the user to confirm initiation of the dynamic offer generation process with the selected primary product. In response to detecting a user input confirming the offer generation process (e.g., at the affordance displayed within the instance of the user portal), the computer system can generate a basket (e.g., digital shopping cart) including the primary product selected by the user.

In one implementation, upon updating the basket to include the primary product, the computer system can extract a set of basket characteristics from the user's basket to evaluate intent of the user to select other products for purchasing in this basket. For example, in response to receiving selection of a first primary product by the user, the computer system can: initialize a basket for the user including the first primary product; and extract a set of basket characteristics including a category (e.g., apparel, jewelry, sporting goods, home goods) of the first primary product, a type (e.g., shirt, pants, dress, socks) of the first primary product, a value of the first primary product (e.g., a dollar amount), a total value of the basket, the merchant offering the first primary product, a current time of day, a device type (e.g., operating system) of the user, and/or current geographic location of the user. The computer system can then leverage these basket characteristics to selectively serve secondary products paired with rewards to the user.

### 6. Intent

Block S120 of the method S100 recites characterizing a first predicted intent of the user for selection of a first secondary product, in the set of products, based on the set of basket characteristics. In particular, upon receiving selection of a primary product by the user, the remote computer system can characterize intent of the user to purchase a set of secondary products based on the set of basket characteristics (e.g., products selected, types of products selected, value of products selected, user demographics) in Block S120. The computer system can then leverage this predicted intent to selectively serve reward packages—including pairs of secondary products and rewards—to the user.

For example, in response to receiving selection, from the user, of a first primary product (e.g., frying pan #5), from a first set of products offered by a particular merchant, the computer system can: initialize a basket for the user including the first primary product; and extract a set of basket characteristics from the basket including a type of primary product (e.g., a frying pan), a category of the primary product (e.g., cookware), a value of the primary product (e.g., $70); geographic location of the user (e.g., San Francisco, Calif., USA); and/or whether the user is located within or proximal a store front of the merchant (e.g., “remote user”). Then, based on these basket characteristics, the computer system can characterize a first predicted intent of the user to select a first secondary product, from the set of products, to add to her basket. In particular, the computer system can: access historical purchase data (e.g., average basket value, average quantity of products selected, combinations of products selected, user demographics) for purchases of the first primary product at the particular merchant; a type (e.g., spatula), a category (e.g., cooking utensil), and/or a value (e.g., $20) of the first secondary product; and leverage this data to characterize a predicted intent of the user, representative of the user's propensity to purchase the first secondary product. The computer system can then repeat this process for each available secondary product, in the set of products, to isolate a subset of secondary products to serve to the user based on the user's predicted intent for each secondary product in the subset of secondary products. Thus, the computer system can leverage intent of the user to identify secondary products to serve to the user based on the primary product selected by the user.

In one implementation, the computer system can characterize the user's intent in the form of a quantitative intent score. For example, in response to receiving selection of a pair of winter boots from the user, the computer system can: characterize a first intent score for the user as “high” for purchase of a pair of wool socks; characterize a second intent score for the user as “low” for purchase of a pair of shorts; and characterize a third intent score as “moderate” for a purchase of a pair of mittens. In this example, the computer system can select the pair of wool socks and the pair of mittens for serving to the user in a reward package and discard the pair of shorts based on the “low” intent of the user to purchase this particular product. Alternatively, in another example, in response to receiving selection of the pair of winter boots from the user, the computer system can: characterize a first intent score of “90%” for the user for purchase of the pair of wool socks; characterize a second intent score of “25%” for the user for purchase of the pair of shorts; and characterize a third intent score of “70%” for the user for purchase of the pair of mittens.

In another implementation, the computer system can characterize intent of the user as an intent profile for the user. For example, for a particular secondary product, the computer system can: estimate an initial intent score for the user based on an initial price (e.g., $100) of this secondary product; estimate a first intent score based on a first price (e.g., $90) less than the initial price; estimate a second intent score based on a second price (e.g., $80) less than the first price; and estimate a third intent score based on a third price (e.g., $70) less than the second price. The computer system can then compile these data to generate an intent profile—for this user and for this particular secondary product—representative of the user's intent to purchase the secondary product when paired with different reward values. Additionally, the computer system can repeat this process for each secondary product, in a set of products, offered by the merchant to generate a composite intent profile for the user. The computer system can then leverage this composite intent profile to select a subset of secondary products, from the set of products, to serve to the user in a reward package.

### 6.1 Intent Model

The computer system can implement an intent model configured to predict whether the user will purchase a particular secondary product offered by a merchant based on historical sales data for products sold by the merchant. In particular, the computer system can access an intent model configured to intake the set of basket characteristics and output an intent score for a particular secondary product for the user.

In one implementation, the computer system can: leverage the intent model to estimate an intent score for the user, representative of a likelihood that the user purchases a particular product offered by the merchant (e.g., when paired with or without a reward); and select reward packages (i.e., secondary product and reward pairs) to suggest to the user based on this intent score. For example, the computer system can store an intent model configured to intake a set of products offered by the merchant, a set of primary products initially selected by the user from the set of products, descriptions of products in the set of products, pricing information for the set of products, and/or historical sales data from the merchant; and output an intent score (e.g., a probability) indicative of the user's propensity to purchase a set of secondary products in the set of products offered by the merchant.

### 6.2 Generating the Intent Model

Generally, the computer system can generate (i.e., construct) a set of models enabling dynamic offer generation for a set of products offered by a merchant based on the types of products sold by the merchant, descriptions of these products, pricing information on these products, and historical sales data retrieved from the merchant in order to calculate the magnitude (e.g., value) of rewards associated with particular products or combinations of products, thereby enabling the dynamic offer generation process to yield attractive discounts on products of interest to a particular user while maintaining and/or increasing profitability to the merchant when offering these discounts.

### 6.2.1 Product Model

In one implementation, the computer system: prompts the merchant to confirm dynamic offer generation for a set of products offered by the merchant; generates a product database for the set of products based on product information supplied by the merchant; retrieves historical sales data from the merchant for this set of products; and generates a multi-order model that predicts probability that purchase of a particular product will occur with purchase of multiple other products in this set of products offered by the merchant.

For example, the merchant can enable a set of 1000 products, [product₁] through [product₁₀₀₀], for dynamic offer generation processes facilitated by the computer system according to the method S100. In this example, the computer system applies statistical methods (e.g., regression analysis), artificial intelligence, and/or machine learning, etc. to historical sales data supplied by the merchant to: derive: a correlation between purchase of [product₁] and purchase of [product₂]; a correlation between purchase of [product₁] and purchase of [product₃]; . . . ; and a correlation between purchase of [product₁] and purchase of [product₁₀₀₀] based on these historical sales data supplied by the merchant. The computer system repeats this process to derive: a correlation between purchase of [product₂] and purchase of [product₃]; a correlation between purchase of [product₂] and purchase of [product₄]; . . . ; and a correlation between purchase of [product₂] and purchase of [product₁₀₀₀] based on these historical sales data supplied by the merchant. The computer system can further repeat this process for [product₃] through [product₁₀₀₀]. The computer system can then compile correlations into a first-order product intent model that predicts probability that purchase of [productₓ] will occur with purchase of [product_{y}]. More specifically, in this example, the product intent model can output “intent scores” representing probabilities of purchase of [product₂] through [product₁₀₀₀] by a user when [product₁] is added to the user's basket and/or purchased by the user.

In the foregoing example, the computer system can implement similar methods and techniques to generate a second order product intent model that predicts the probability that purchase of [product_{z}] will occur with purchase of [productₓ] and [product_{y}]. For example, the computer system can apply statistical methods, artificial intelligence, and/or machine learning etc., to historical sales data supplied by the merchant and leverage the first order product intent model to derive: a correlation between purchase of [product₁] and [product₂] and purchase of [product₃]; a correlation between purchase of [product₁] and [product₂] and purchase of [product₄]; . . . ; and a correlation between purchase of [product₁] and [product₂] and purchase of [product₁₀₀₀]. The computer system can then repeat this process for each pair of base products [productᵢ] and [productⱼ] in order to derive correlations between purchase of each possible pair of products and purchase of a third product in the product database. The computer system can then compile these derived correlations into a second-order product intent model that predicts probability that purchase of [product_{z}] offered by the merchant will coincide and/or occur with purchase of [productₓ] and [product_{y}]. More specifically, in this example, the product intent model can output intent scores representing probabilities of purchase of [product₂] through [product₁₀₀₀] by a user when [productₓ] and [product_{y}] are added to the user's basket and/or purchased by the user.

In the foregoing example, the computer system can implement similar methods and techniques to derive a multi-order product intent model that predicts the probability that purchase of a particular product will occur and/or coincide with the purchase of multiple other products offered by the merchant (e.g., four other products, ten other products).

Thus, the computer system can leverage the product intent model to rank, order, and/or select additional products for presentation to the user during the dynamic offer generation process according to purchase probability and/or propensity based on the user's purchase intent and any additional products in the user's basket.

### 6.2.2 Basket Size Model

In another implementation, the computer system: prompts the merchant to confirm dynamic offer generation for a set of products offered by the merchant; generates a product database for the set of products based on product information supplied by the merchant; retrieves historical sales data from the merchant for this set of products; and generates a basket size model that predicts the total amount a user will spend in a transaction (e.g., across all purchases) when purchasing a particular product (e.g., a primary product associated with the user's purchase intent).

For example, the merchant can enable a set of 1000 products, [product₁] through [product₁₀₀₀], for dynamic offer generation processes facilitated by the computer system according to the method S100. In this example, the computer system applies statistical methods (e.g., weighted averaging) to historical sales data supplied by the merchant to calculate an average basket size for all purchases that included [product₁]. The computer system can also calculate a standard deviation in basket size, variance in basket size, minimum basket size, and maximum basket size across all purchases that included [product₁]. The computer system can then repeat this process for each other product (e.g., [product₂] through [product₁₀₀₀]) in the product database generated for the merchant and compile the calculated average basket sizes into a first-order basket size model that predicts a total basket size (e.g., including other possible purchases) when purchasing a particular product.

In the foregoing example, the computer system can implement similar methods and techniques to generate a second-order basket size model that predicts the total basket size (e.g., including other possible purchases) when purchasing a particular pair of products. Additionally and/or alternatively, the computer system can implement similar methods and techniques to generate a multi-order basket size model that predicts a total basket size (e.g., including other possible purchases) when purchasing multiple other products (e.g., three particular products, ten particular products).

Thus, during the dynamic offer generation process, the computer system can leverage the basket size model to calculate and/or predict an estimated amount a user is likely to spend across all purchases based on the user's indicated purchase intent and/or other products in the user's basket. In particular, the computer system can then associate a predicted basket size generated by the basket size model given a particular primary product with the merchant's expected revenue for the transaction in the absence of an offer (e.g., an amount the user may spend on undiscounted purchases) and calculate a range of acceptable reward values associated with particular products and/or baskets based on this predicted basket size.

### 6.2.3 Customer Model

In another implementation, the computer system can leverage historical demographic data for transactions at the merchant to generate a customer model for predicting the user's intent to purchase secondary products.

For example, the computer system can: retrieve historical sales data from the merchant, including individual products purchased, total basket size, and any promotional offers and/or discounts used for each transaction; retrieve customer demographic data for each transaction, including age, gender, location (e.g., city, state, region, in-store versus online transaction), mobile device operating system etc. of the corresponding customer; and implements statistical methods (e.g., regression analysis), artificial intelligence, machine learning techniques etc. to derive correlations between customer demographic data, total basket size, and individual products purchased.

The computer system can then compile these derived correlations into a general customer model that can predict: propensities and/or modifications to propensities of a user toward purchase of particular products based on user demographics; and/or total basket size and/or modifications to total basket sizes calculated for the user. Additionally and/or alternatively, the computer system can: incorporate derived correlations between user demographics characteristics, individual products purchased, and groups of products purchased into the product intent model; and incorporate derived correlations between user demographic characteristics and basket size into the basket size model. For example, the computer system can modify, mask, or customize the product intent model (or outputs of the product intent model) based on demographic data for the user indicating a particular propensity for purchasing individual products purchased and/or groups of products from the merchant. Similarly, the computer system can also modify, mask, or customize the basket size model (or outputs of the basket size model) based on the user's particular propensity for a particular basket size for purchases from the merchant.

In one variation, the computer system can infer (e.g., automatically determines) a purchase intent of the user—without selection of a primary product by the user—based on the customer model. For example, the computer system can input user demographics and/or purchase histories of a particular user (such as including past offers generated for the user) into the customer model to calculate a set of intent scores for a set of products offered by the merchant. The computer system can then predict the user's purchase intent based on these intent scores and select a primary product from the set of products offered by the merchant to begin the dynamic offer generation process based on the predicted purchase intent. The computer system can therefore leverage the customer model to initiate the dynamic offer generation process based on an inferred purchase intent of the user without receiving explicit selection of a primary product from the user. The computer system can then continue the dynamic offer generation process by prompting the user to select a next product from a (sub)set of products offered by the merchant, as described below.

### 6.3 User-Specific Intent Model

In one variation, the computer system can generate a user-specific intent model configured to intake a set of basket characteristics (e.g., a type of primary product, a price associated with the primary product, a geographic location of the user, a time of day) and to output a predicted intent score for purchase of a particular secondary product. For example, as a user selects and discards rewards offered to her (e.g., within the native application) over time, the computer system can: record product characteristics (e.g., types, prices, promotional discounts, product groupings) that the user selected; record product characteristics that the user discarded; and record setting variables (e.g., time of day, device location, local weather conditions). The computer system can then implement statistical analysis, regression, and/or artificial intelligence, etc. to: derive the user's typical spending habits or basket characteristics of purchases by the user; and compile these spending habits in a user-intent model that predicts the user's likelihood of purchasing a set of products based on product characteristics and current setting variables. The computer system can therefore “learn” purchase habits of the user, such as: types of products purchased together; average basket value (e.g., average dollar amount of baskets purchased); average product value (e.g., average dollar amount of individual products purchased); frequent merchants and/or types of merchants; geographic shopping preferences (e.g., online or in-store); maximum purchase amount (e.g., for a product, for a basket); habitual purchases; etc. The computer system can then leverage this data to generate a user-specific intent model for this particular user.

Thus, during the dynamic offer generation process, the computer system can leverage the general customer model and/or a customer model specific to a user to: more accurately identify secondary products that may be of interest to the user; refine calculated propensities of the user to purchase particular products and/or groups of products according to user demographics and/or purchase habits of the user; and refine estimates of total basket sizes (e.g., based on the user's indicated purchase intent) according to user demographics and/or purchase habits of the user in order to more accurately calculate acceptable reward values that may be offered alongside particular products and/or groups of products.

In one implementation, the computer system can leverage a generic intent model (e.g., customer model, product model, basket size model) to initially select secondary products and rewards for serving to a new user. Over time, based on the new user's selection of these secondary products and rewards, the computer system can implement the foregoing methods and techniques to generate a user-specific intent model for this user, such as by updating the generic intent model based on additional data collected from the user over time.

For example, the computer system can initially leverage the generic intent model to select a first reward package for serving to a new user responsive to selection of a first primary product by the new user, the first reward package including: a first secondary product paired with a first reward; and a second secondary product paired with a second reward. In response to the user selecting the first secondary product paired with the first reward, the computer system can record: a product type of the first primary product; a product type of the first secondary product; a value of the first reward; a format of the first reward; a total value of the user's basket including the first primary product and the first secondary product; a current time of day; and/or a location of the user (e.g., geographic location, at her home or at a storefront of the merchant). The computer system can then leverage these data to modify the generic intent model based on the user's selection. Therefore, by repeating this process for each product and reward selected by the user over time, the computer system can modify, mask, or customize the generic intent model (or outputs of the intent model) based on the user's particular propensity for selecting individual products and/or groups of products to generate a user-specific intent model.

The computer system can therefore further modify and/or customize this generic intent model (e.g., the customer model, the product model, and/or the basket size model) for a particular user based on: sales data from past transactions with the particular user; and/or decisions and selections made by the particular user during previous instances of the dynamic offer generation process. Thus, the computer system can implement similar techniques as described above to update and/or modify calculated propensities toward purchase of particular products or sets of products and expected basket sizes for the particular user based on that user's particular purchase history and/or purchase habits.

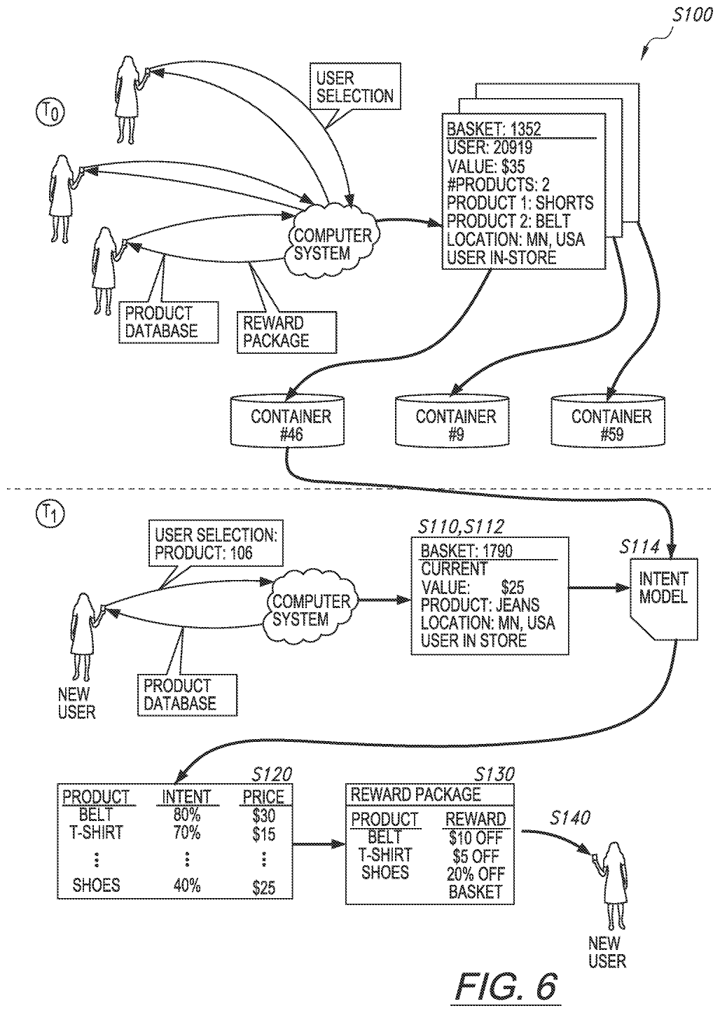

In another implementation, as shown in FIG. 6, the computer system can identify a particular user (or a particular composite representation of a group of similar existing users) that exhibit similar demographics (e.g., age, gender, geographic location) and/or behaviors (e.g., purchase habits) of a new user with limited purchase data. The computer system can then leverage these more comprehensive purchase data of the existing user (or the particular composite representation of multiple existing users) to predict the new user's intent with greater confidence and/or accuracy, rather than relying exclusively on a generic intent model or on limited purchase data collected from the new user over a limited period of time.

For example, the computer system can: assign a large weight to limited existing purchase data of the new user; assign a lesser weight to limited existing purchase data of the particular existing user (or the particular composite representation of multiple existing users) matched to the new user; combine these weighted purchase data into a composite body of purchase data for the new user; and then generate an initial user-specific intent model for predicting the user's current intent to purchase a set of secondary products based on this composite body of purchase data. Alternatively, the computer system can pass this composite body of purchase data into a generic intent model or an intent model associated with the particular existing user to predict the user's current intent to purchase a set of secondary products.

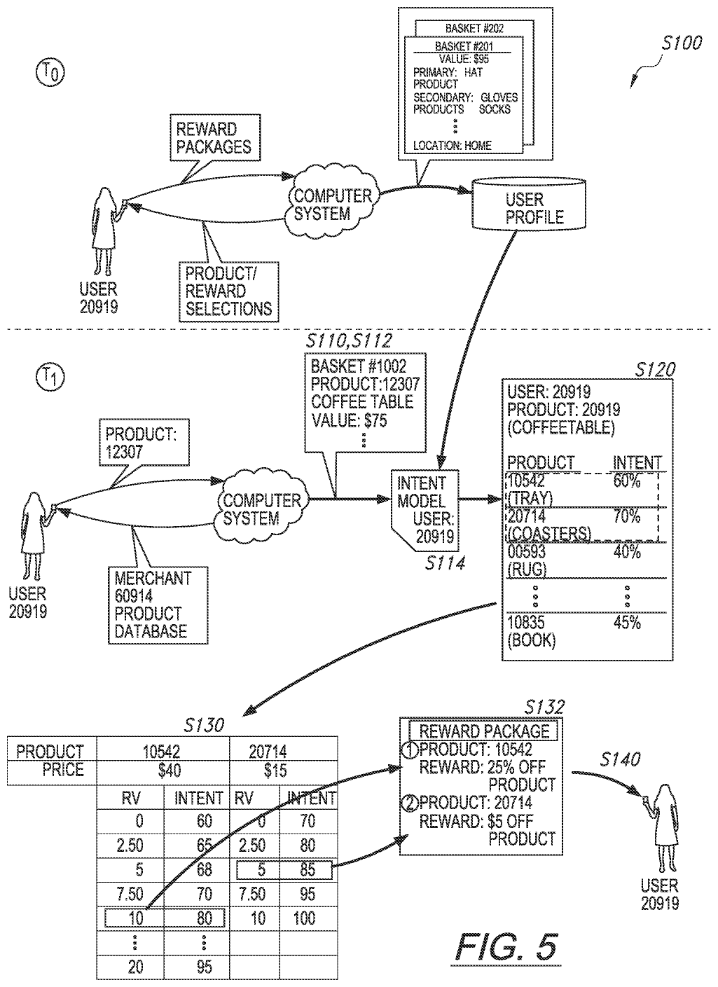

In another implementation shown in FIG. 5, the computer system can learn user-specific purchase habits by serving a variety of secondary products and rewards to a new user over an initial set-up period. The computer system can then aggregate purchase data collected during this initial set-up period to generate a user-specific intent model for the new user. For example, at a first time, in response to receiving selection of a pair of jeans by a new user, the computer system can offer a first reward of “50% off your purchase” of a first secondary product (e.g., a belt) to the new user. The computer system can then record whether the user selects or discards the first reward and first secondary product. Later, at a second time, in response to receiving selection of a shirt by the new user, the computer system can offer a second reward of “30% off your purchase” of a second secondary product (e.g., a hat) to the new user. Similarly, the user computer system can record whether the user selects or discards the second reward and the second secondary product. Then, at a third time succeeding the second time, in response to receiving selection of a dress by the new user, the computer system can offer a third reward of “10% off your purchase” of a third secondary product (e.g., a pair of shoes) to the new user. Again, the computer system can record whether the user selects or discards the third reward and the third secondary product. By serving the user many rewards corresponding to different reward values, the computer system can gauge the user's price-sensitivity to better predict types of products and rewards to serve this user in the future. In this example, the computer system can: store this data in a user profile (e.g., within a session container) for the user; and leverage the data to generate a user-specific intent model for predicting intent of this particular user. Alternatively, the computer system can leverage the data stored in the user profile—and updated over time—to modify an existing generic intent model to better predict intent of this particular user.

Alternatively, the system can implement a generic intent model to select secondary product and reward pairs for serving to the user, such as if limited information about the user is available.

### 6.3.1 User Profile

In one variation, the computer system can compile purchase data collected over time for the user into a user profile. This user profile can thus include information representing the user's historical interactions with a particular merchant such as: each product purchased; products purchased together in a single basket; pairs of secondary products and rewards selected by the user; pairs of secondary products and rewards rejected by the user; average basket size (e.g., average quantity of products in a basket, average value of products in a basket); time and location of each purchase; etc.

For example, for each basket confirmed by the user, the computer system can store a set of purchase data (e.g., descriptions of each product purchased, value of each product purchased, total value of the basket, reward(s) added to the basket, time of day purchase completed, geographic location of the user). Then, based on each set of purchase data, the computer system can calculate a set of purchase metrics for the user and store these purchase metrics at the user profile. The computer system can then update the set of purchase metrics each time the user confirms a new basket, based on purchase data of the new basket.

In one implementation, the computer system can host or interface with a user portal—executing on the user's computing device (e.g., a mobile device, a computer)—to configure a user profile for the user. For example, the user may download the native application to her smartphone and create a new user profile. The user may manually populate the new user profile with various information, such as: name, age, gender, geographic location (e.g., a region in which the user resides), contact information (e.g., phone number, email address, shipping address), etc. The computer system can leverage demographic information (e.g., age, gender, geographic location) provided by the user in the user profile to better predict intent of the user to select various secondary products and rewards (e.g., based on the user-specific intent model). Additionally and/or alternatively, the computer system can leverage data contained in the user profile to generate a user-specific intent model for the user for predicting intent of the user to purchase various products as described above.

### 7. First Set of Secondary Product and Reward Pairs

The computer system can leverage intent of the user to select a reward package—including pairs of secondary products and rewards—to serve to the user. In particular, the computer system can: characterize intent of the user to purchase a particular secondary product; and, based on the user's intent, select a reward for pairing with the secondary product configured to both increase the user's intent to purchase the secondary product and increase sales (e.g., quantity of purchases, revenue from purchases) for the merchant.

The computer system can characterize the user's initial intent to purchase a particular secondary product (e.g., based on a starting price listed for the particular secondary product). Based on the user's initial intent, the computer system can identify a target intent (e.g., corresponding to a maximum expected revenue for the merchant) for this user for this particular secondary product. Then, the computer system can calculate a reward value configured to drive (e.g., increase) the user's initial intent toward to the target intent.

For example, the computer system can calculate an intent score for the user for purchase of a first secondary product based on the set of basket characteristics (e.g., type of primary product, value of primary product, time of day, location of user) and the intent model. The computer system can then access a target intent score, exceeding the first intent score, for this particular secondary product for this user. Based on a difference between the target intent score and the intent score of the user, the computer system can select a first reward value for pairing with the first secondary product configured to drive the intent of the user toward the target intent, thereby increasing a likelihood of the user selecting the first secondary pairing to add to her basket. In this example, the computer system can access a particular target intent score calculated for this particular user and/or for the first secondary product. Alternatively, the computer system can access a generic target intent score (e.g., defined by the merchant) for the first secondary product and/or for all secondary products offered by the merchant.

In one implementation, to select a reward value configured to drive the intent of the user toward the target intent, the computer system can calculate a set of adjusted intent scores for the user, each adjusted intent score corresponding to a different reward value paired with the secondary product. For example, the computer system can: calculate a first adjusted intent score for a first reward value paired with a first secondary product based on the intent model, the set of basket characteristics, and the first reward value. In response to the first adjusted intent score falling within a threshold deviation of the first target intent score, the computer system can store the first reward value as the first minimum reward value. The computer system can then repeat this process for a second reward value greater than the first reward value to calculate a second adjusted intent score for the second reward value paired with the first secondary product, the second adjusted intent score greater than the first adjusted intent score. Then, in response to the second adjusted intent score falling within the threshold deviation of the target intent score, the computer system can: calculate a first deviation between the first adjusted intent score and the target intent score; calculate a second deviation between the second adjusted intent score and the target intent score; and in response to the first deviation exceeding the second deviation, store the second reward value as the first minimum reward value. The computer system can repeat this process for each reward value in a set of reward value to select a final reward value configured to drive the intent of the user closest toward the target intent.

In one variation, the computer system can: calculate a first set of intent scores for purchase of products, in a first set of products offered by the merchant, by the user based on the primary product and purchase history of customers at the merchant; and calculate a first set of expected revenues associated with the first set of products based on the set of intent scores and prices of products in the first set of products. In this implementation, the computer system can: calculate purchase probabilities for secondary products offered by the merchant based on the purchase intent specified by selection of the primary product; calculate expected revenues for the merchant for each possible secondary product based on these probabilities and the prices of each secondary product; generate a set of possible offers (e.g., offer paths) that include the primary product, a secondary product, and a reward associated with the purchase of the secondary product; and rank (e.g., order) the set of possible offers according to expected revenues associated with purchase of secondary products in each offer.

For example, the computer system can input the primary product into the first-order product intent model to obtain intent scores for a first set of other products (e.g., [product₂] through [product₁₀₀₀] carried by the merchant) as a function of selection of [product₁] by the user. For each product in the first set of products, the computer system can then: calculate a combination (e.g., product) of the intent score of the product and the price of the product and store this combination as an expected revenue for the product. In this example, the computer system can then select a subset of (e.g., three) secondary products associated with the highest expected revenues in the first set of products. Thus, by weighting the intent score of each product by the product's price, the computer system can calculate an expected basket size associated with each product in the first set of products and rank products and/or offers according to the largest expected basket size (e.g., highest expected revenues among secondary products).

In this variation, the computer system can: calculate a nominal amount that the user is predicted to spend on other products offered by the merchant in the absence of a reward (e.g., a discount); calculate a maximum reward value that can be offered with each secondary product; and calculate an actual reward value by scaling (e.g., reducing) the maximum reward value according to the prices of the primary and secondary product, expected revenues, etc.

In one implementation, the computer system can then input the primary product into the first-order basket size model in order to estimate a first-order predicted basket size for an undiscounted transaction, such as in the form of: an average basket size, a range of basket sizes (e.g., within one standard deviation of a mean), and/or maximum and minimum basket sizes based on historical purchases that included the primary product. Thus, the computer system can estimate a nominal basket size representing the total (e.g., average) amount that the user would be expected to spend on undiscounted products in the absence of any reward offered by the computer system.

The computer system can then calculate a maximum acceptable reward value for each secondary product in the first subset of products (e.g., associated with the largest expected revenues) based on the predicted nominal basket size and the expected revenue associated with each product. In one implementation, for each secondary product, the computer system can: input the primary product and the secondary product into the second-order basket size model to calculate a second-order predicted basket size for the current transaction, including the primary product and the secondary product; and calculate an upper bound for a reward value on a basket including the primary product and the secondary product based on a difference between the first-order basket size and the second-order basket size. For example, in response to calculating a nominal first-order basket size of $100 for a basket including the primary product, and a predicted second-order basket size of $150 for a basket including the primary product and a particular secondary product, the computer system can set $50 as the maximum value of a reward associated with that secondary product.

In another implementation, for each secondary product, the computer system can calculate an upper bound for a reward value on a basket including the primary product and the secondary product based on a difference between the expected revenue associated with the secondary product and the price of the secondary product. For example, if the computer system calculates an expected revenue of $40 for a $100 pair of shoes (e.g., 40% probability of purchase along with the primary product without any discount), the computer system can set a maximum reward value associated with purchasing the pair of shoes at $60. However, if the computer system calculates an expected revenue of $15 for a $20 shirt (e.g., 75% purchase probability of purchase along with the primary product without any discount), the computer system can set a maximum reward value associated with purchasing the shirt at only $5.

Thus, the computer system can determine a maximum discount (or “break-even” point) that can be offered as a reward for purchase of a secondary product based on the difference between revenue expected for an undiscounted transaction including the primary product (e.g., revenue in the absence of an offer) and price and/or predicted price of a basket including the primary product and the secondary product.

For example, subsequently and/or concurrently, the computer system can select a reward format associated with the secondary product by retrieving a reward format from a set of reward formats specified for the secondary product in the product database (e.g., “percentage-discount”, “reward points”, “buy one, get one free”).

The computer system then sets the magnitude (e.g., value) of the reward to be associated with the secondary product as a fraction of the maximum reward value. In particular, the computer system can calculate this fraction of the maximum reward to balance profitability for the merchant (e.g., increase revenue) against discounts for the consumer (e.g., to increase likelihood of the user redeeming and/or executing the resulting offer). In one implementation, to calculate the reward value, the computer system can: sum the prices of the primary and secondary products; calculate a price difference between this sum and the first-order predicted basket size; and set the value of the reward—between a minimum value up to the upper bound for the value of the offer—as a function of (e.g., proportional to, inversely proportional to) this price difference. For example, for a “percentage-discount” reward format, the computer system can calculate a total price (e.g., $100) of the primary product selected by the user and a secondary product associated with a high expected revenue; calculate a difference (e.g., $25) between the total price and the first-order predicted basket size (e.g., $75); and set the value of the “percentage-discount” reward (e.g., to the primary product) between a minimum reward value (e.g., 5% discount, or $5) and the maximum reward value (e.g., $25, or 25% discount) proportional to difference in basket sizes. In another example, for a “buy one, get one free” reward format, the computer system can: calculate a difference between the first-order predicted basket size and total price of a basket containing the primary product and a secondary format (e.g., $25); set the reward value (e.g., $10) as a portion of the maximum reward value as a function of this difference; select a third product associated with a high intent score (e.g., based on an output of the product intent model); and offer the third product for free as the reward.

Furthermore, in this implementation, the computer system can: input demographics of the user into the customer model in order to obtain a probability of purchase completion by the user based on histories of users with similar demographic characteristics converting offers previously generated by the computer system; and scale the value of the reward inversely with probability of purchase completion. Additionally and/or alternatively, the computer system can access a model of the particular user, including a total value across life-time purchases from the merchant and/or reward values associated with offers previously converted by the particular user, and scale the calculated reward value according to a probability of purchase completion calculated for that particular user.

Thus, the computer system can calculate the reward value associated with a secondary product based on prices of the primary and secondary products, expected revenues, and user characteristics in order to create an offer on the secondary product that increases revenue for the merchant while also maintaining a high probability of purchase completion by the user.

The computer system can repeat these methods to calculate reward values for each other secondary product in the selected subset of products in order to generate a first set of secondary product and reward pairs for presentation to the user.

### 7.1 Reward Types and Parameters

Generally, the computer system can pair each product in the product database for a merchant with a reward format or a set of reward formats that can be defined by the merchant and/or selected based on the type of product and/or the type of merchant. For example, reward formats can include: a percentage discount to the price of a particular product (e.g., a primary product specified by the user's purchase intent); a percentage discount to the total basket price; a fixed value discount; buy one, get one free at the time of purchase; buy one, get one free at a later purchase; a percentage discount to a subsequent purchase; or a percentage discount to the total basket price if exceeding a particular basket value.

In particular, the computer system can specialize different subsets of reward formats across different types of products and/or different types of merchants. For example, the computer system may offer rewards that are redeemable during a subsequent transaction for a merchant offering lower-priced, habitually purchased products (e.g., a coffee shop), but exclude such reward formats for a merchant (e.g., a clothing store) offering higher-priced products purchased with less frequency (e.g., by any given user).

Subsequently and/or concurrently, the computer system calculates a value (e.g., monetary value) of rewards associated with each product and/or baskets of products created during the dynamic offer generation process. While the computer system can offer (substantial) discounts on a product associated with the user's purchase intent and/or the total basket price, the computer system generally restricts the range of acceptable reward values to a maximum value associated with a particular product and/or group of products such that discounted baskets result in an overall revenue increase for the merchant (e.g., through purchase of additional products beyond the user's stated purchase intent), as described in more detail below.

In one variation, the computer system can access rewards previously served to the user to inform selection of a next reward or reward format for the user. For example, the computer system can store a first reward—defining a first reward type (e.g., “$10 off your total purchase”) and a first reward value (e.g., ten dollars)—previously served to the user at the user profile. Later, when selecting a second reward to serve to the user, the computer system can: access the user profile to extract the first reward; and, in response to a second reward value (e.g., ten dollars) for the second reward matching the first reward value for the first reward, select a second reward type (e.g., “20% off your purchase”)—distinct from the first reward type—for generating the second reward. In another example, the computer system can implement a rolling window, such that no reward is served to the user more than once within a threshold period of time (e.g., one month, one year) and/or within a threshold quantity of reward packages curated for this user.

### 8. User Action: Selection of Secondary Product

Upon selection of each secondary product and each corresponding reward, the computer system can present the first reward package to the user at the computing device. Then, in response to receiving selection of a particular secondary product from the user, the computer system can add this particular secondary product—and corresponding reward—to the user's basket.

In one implementation, the computer system can display the first reward package to the user via a first user interface including: a representation of each secondary product in the selected subset of products; reward formats and reward values paired with each secondary product; and a prompt to select a secondary product from the displayed subset of products. For example, the first user interface can include: an image, a description and a price of each secondary product; and/or a representation of the reward format and reward value paired with each secondary product (e.g., “25% discount for the primary product” paired with [productₓ], “15% discount for the basket price” paired with [product_{y}]). The first user interface may also include a prompt (e.g., a banner notification) to continue the dynamic offer generation process by selecting among the displayed secondary product and reward pairs. In response to receiving a user selection of a particular secondary product (e.g., an input at an affordance associated with secondary product), the computer system can display an affordance prompting the user to confirm selection of the indicated secondary product and the reward associated with the secondary product. In response to detecting a user input confirming selection of the secondary product (e.g., an input at the confirm affordance), the computer system can add the selected secondary product and the associated reward to the basket.

### 9. System Response: Second Set of Recommended Product and Reward Pairs

In one variation, the computer system can generate a second reward package for serving to the user responsive to receiving selection, by the user, of the first secondary product paired with the first reward. In this variation, the computer system can select a second set of secondary products paired with reward for including in the second reward package according to the methods described above. Additionally, the computer system can leverage selection of the first secondary product paired with the first reward to reevaluate the user's current intent. Therefore, the computer system can identify additional secondary products and rewards to serve to the user in the second reward package based on this current intent of the user.

For example, in response to receiving selection of a first secondary product, in a first reward package, from the user, the computer system can: estimate a second intent score for the user for purchase of a second secondary product, in the set of products, based on the primary product, the first secondary product and/or first reward, and historical purchases of products at the merchant; and calculate a second minimum reward value predicted to increase the second predicted intent score toward a second target intent score for the second secondary product. Then, in response to the second minimum reward value falling below a second maximum reward value for the second secondary product, the computer system can select a second reward for pairing with purchase of the second secondary product based on the second minimum reward value; and populate a second reward package with the second reward paired with the second secondary product. The computer system can then repeat this process to select additional secondary products for including in the second reward package before serving the second reward package to the user.

In one variation, Blocks of the method S100 further recite: calculating a second set of intent scores for purchase of secondary products, in a second set of secondary products offered by the merchant, by the user based on the primary product, the first secondary product, and purchase history of customers at the merchant in Block S160; and calculating a second set of expected revenues for the second set of products based on the second set of intent scores in Block S164. Generally, in this variation, the computer system can: update purchase probabilities for additional products offered by the merchant based on the secondary product selected by the user; update expected revenues for the merchant for each additional product based on these updated propensities and prices of additional product; generate an updated set of possible offers (e.g., offer paths) that include the primary product, a secondary product, an additional product, the reward associated with the secondary product, and a second reward associated with the purchase of the additional product; and rank (e.g., order) the updated set of possible offers according to updated expected revenues associated with purchase of additional products.

In one implementation, the computer system can input the primary product and the secondary product selected by the user into the second-order product intent model to obtain new (e.g., updated) intent scores for a set of other products (e.g., [product₃] through [product₁₀₀₀] carried by the merchant) as a function of selection of [product₁] and [product₂] by the user. For each product in the set of other products, the computer system can then calculate a combination (e.g., product) of the new intent score of the product and the price of the product and store this combination as an updated expected revenue for the product.

Blocks of the method S100 recite: selecting a second subset of products in the first set of products based on the set of expected revenues in Block S166. In particular, the computer system can select a second subset of (e.g., three) additional products associated with the highest expected revenues in the set of other products. Thus, the computer system can select several additional products from the remaining set of products offered by the merchant as a function of purchase probability (e.g., relevance to the user) and potential revenue generation for the merchant.

Blocks of the method S100 further recite: for each product in the second subset of products, calculating a second reward corresponding to the product based on an updated expected revenue associated with the product and the first reward in Block S170. Generally, the computer system can: calculate a maximum second reward value that can be offered with each additional product; and calculate an actual second reward value by scaling (e.g., reducing) the maximum second reward value according to the value of the first reward, basket size (e.g., including the additional product), and/or expected revenues, etc.

In particular, the computer system can derive (e.g., calculate) an upper bound on the value of the second reward according to similar methods and techniques used to calculate the maximum value of the first reward. For example, for each additional product, the computer system can: input the primary product, the secondary product selected by the user, and the additional product into a third-order basket size model to calculate a third-order predicted basket size for the current transaction, including the primary product, the selected secondary product, and the additional product; and calculate an upper bound for a second reward value on a basket including the primary product, the selected secondary product, and the additional product based on a difference between the third-order basket size and the second-order basket size. In another example, the computer system can calculate an upper bound for a reward value on a basket including the primary product, the selected secondary product, and the additional product based on a difference between the expected revenue associated with the additional product and the price of the additional product.

After selecting a reward format for the second reward (e.g., “percentage-discount”, “reward points”, “buy one, get one free”, “cash value”), the computer system can set the value of the second reward by scaling the maximum second reward value according to similar methods and techniques used to set the value of the first reward. However, the computer system can further scale the value of the second reward based on the value of the first reward associated with the secondary product selected by the user. For example, if the value of the first reward is small relative to the maximum value of the first reward (e.g., the first reward favors the merchant), the computer system can increase the value of the second reward in order to increase the user's probability of purchase completion. Conversely, if the value of the first reward is large relative to the maximum value of the first reward, the computer system can decrease the value of the second reward in order to increase revenue for the merchant.

Thus, the computer system can calculate a reward value associated with an additional product based on the value of the reward offered for the secondary product, basket size, expected revenue from the additional product, and user characteristics in order to create an offer on the additional product that increases revenue for the merchant while maintaining a high probability of purchase completion by the user.

The computer system can repeat these methods to calculate reward values for each other additional product in the second subset of selected products in order to generate a second set of additional product and reward pairs for presentation to the user.

### 10. User Action: Selection of Additional Product

In one variation, Blocks of the method S100 further recite: presenting the second subset of products and corresponding rewards to the user via the computing device in Block S180; and in response to receiving selection of a second secondary product, in the second subset of products, by the user at the computing device, adding the second secondary product and the second reward to the basket in Block S190.

Following selection of the second secondary product, the computer system can display a second user interface including: a representation of each secondary product in the second selected subset of products; reward formats and reward values paired with each secondary product; and a prompt to select an additional product from the displayed second subset of products. For example, the second user interface can include: an image, a description and a price of each secondary product; and/or a representation of the reward format and reward value paired with each secondary product (e.g., “additional 20% discount for the primary product” paired with [productₓ], “free product of equal or lesser value” paired with [product_{y}]). The second user interface may also include a prompt (e.g., a banner notification) to continue the dynamic offer generation process by selecting among the displayed secondary product and reward pairs. In response to receiving a user selection of a particular additional secondary product (e.g., an input at an affordance associated with additional secondary product), the computer system can display an affordance prompting the user to confirm selection of the indicated additional secondary product and the reward associated with the additional secondary product. In response to detecting a user input confirming selection of the additional secondary product (e.g., an input at the confirm affordance), the computer system can add the selected secondary product and the associated reward to the basket in Block S190.

### 11. Exit Conditions and Offer Finalization

In one variation, Blocks of the method S100 recite: generating a purchase code pairing the first reward and the second reward with purchase of the primary product, the first secondary product, and the second secondary product in Block S192.

Generally, the computer system can end the dynamic offer generation process in response to certain exit conditions. In one implementation, the computer system may end the dynamic offer generation process and finalize an offer on products selected by the user following a predetermined number of selections (e.g., two selections, three selections, five selections) made by the user. In particular, the computer system can set the number of selections (e.g., steps) required to finalize the offer based on the merchant or type of merchant. For example, the computer system can set a small number of selections (e.g., two selections) for merchants that sell a high volume of low-cost, habitually purchased products (e.g., a coffee shop). For other types of merchants (e.g., a clothing store), the computer system can require a larger number of selections (e.g., five selections) in order to finalize an offer. In another implementation, the computer system may end the dynamic offer generation process and finalize an offer on products selected by the user once the basket size (e.g., total price of selected products) exceeds a threshold amount.

In response to satisfaction of an exit condition, the computer system can automatically end the dynamic offer generation process and finalize an offer including the rewards and products selected by the user. Alternatively, once an exit condition has been met, the computer system can provide the user with an option to finalize the offer, or to continue the dynamic offer generation process (e.g., by selecting additional products to add to the current basket).

Upon finalizing the offer, the computer system can display a completion interface that includes a purchase code redeemable at the merchant for rewards (e.g., the first reward and the second reward) related to purchase of the particular products (e.g., the primary product, the secondary product, and the additional product) selected by the user during the offer generation process. For example, the completion interface may include a promotional code that can be entered or copied into a corresponding field during digital checkout at an online retailer in order to apply the rewards to a purchase of the selected products. In another example, the completion interface may include a barcode that can be downloaded and/or saved within an offer generation application and/or an application associated with the merchant and scanned during checkout at the merchant's retail location.

In one implementation, the computer system can generate a time-limited purchase code for the offer that expires after a predetermined period of time (e.g., three days, two weeks). In this implementation, the computer system can be configured to generate notifications (e.g., push notifications from a mobile application cooperating with the computer system) reminding the user of any outstanding (e.g., unredeemed) offers prior to expiration. Furthermore, in response to detecting expiration of an outstanding offer created during a first offer generation process at a particular merchant, the computer system can prompt the user to initiate a second offer generation process with the same merchant. For example, the second offer generation process can be based on the same purchase intent (e.g., primary product) and/or include other products selected by the user during the first offer generation process. During the second offer generation process, the computer system can offer rewards of higher value and/or increase the expiry period on the second offer in order to increase the probability of purchase completion.

### 12. Variation: Reward Selection by the User

In one variation, the computer system calculates a set of reward values associated with secondary products after receiving selection of a particular secondary product from the user and prompts to the user to select among possible rewards associated with her product selection. More specifically, in this variation, the computer system can: receive a selection of a primary product specifying the user's purchase intent (e.g., at a first user interface); calculate a set of intent scores for each product in a set of other products offered by the merchant; identify a subset of products (e.g., three products) in the set of other products, the subset of products corresponding to high intent scores (e.g., based on outputs of the product intent model according to the selected primary product); prompt the user to select (e.g., at a second user interface) a particular secondary product from the subset of products; calculate a set of rewards (e.g., three possible rewards) corresponding to the selected secondary product, each reward including a reward format (e.g., based on the secondary product) and a reward value (e.g., based on the price of the secondary product, an expected revenue associated with the secondary product, and/or outputs of the basket size model according to the primary product); and prompt the user to select a reward from the set of rewards calculated for the selected secondary product. Thus, the computer system enables the user to select a particular secondary product independent of any reward offered, calculates a set of rewards (e.g., of different reward formats) commensurate with the price of the secondary product (e.g., versus predicted basket size and/or expected revenue), and enables the user to select a desired reward from this set of awards to pair with purchase of the selected secondary product. The computer system can then repeat these methods and techniques for any number of other products (e.g., one additional product, three additional products) in order to generate an offer according to indicated user preferences for products and rewards.

### 13. Variation: Primary Product Prediction

In another variation, the computer system can automatically generate an offer—including a subset of products offered by a merchant—for the user without explicit initiation of the dynamic offer generation process by the user. More specifically, in this variation, the computer system can automatically predict a primary product offered by the merchant that the user has a high probability of purchasing based on the customer model (e.g., based on user demographics, purchase history of the individual user). For example, the computer system can: input user demographics and/or purchase histories of a particular user (e.g., including past offers generated for the user); calculate a set of intent scores for a set of products offered by merchant based on outputs of the customer model; and select a primary product—from the set of products offered by the merchant—based on this set of intent scores. The computer system can then execute Blocks of the method S100 to: automatically select additional products to pair with this primary product (e.g., based on outputs of the product intent model for the selected primary products); calculate reward values and reward formats to pair with these additional products; and compile these products, reward values, and reward formats into an automatically-generated offer for the user.

The computer system can then serve this automatically-generated offer to the user's computing device, such as via email, text message, and/or in-application notification. For example, the computer system can execute this process to automatically generate a new offer for a particular merchant on behalf of the user on a regular interval—such as daily, weekly, or monthly—and automatically push these offers to the user.

### 14. Merchant Networks

In one variation, the computer system can generate and supply reward packages to the user including secondary products offered by a set of merchants. In this variation, the computer system can automatically reconcile distribution of rewards between different merchants based on characteristics of the user's basket.

In one implementation, the computer system can: receive selection of a primary product sold by a first merchant from the user; and select a secondary product sold by a second merchant—distinct from the first merchant—to serve to the user.

For example, in response to receiving selection of a first primary product, in a first set of products offered by a first merchant (e.g., a clothing store), the computer system can serve the user a first reward package including: a first secondary product, from the first set of products offered by the first merchant, paired with a first reward (e.g., “10% off your total basket value”); and a second secondary product, from a second set of products offered by a second merchant (e.g., a coffee shop proximal the clothing store), paired with a second reward (e.g., “a free medium-sized beverage”). In response to receiving selection of the second secondary product—paired with the second reward—and confirmation of the basket from the user, the computer system can generate a promotional code or barcode accessible to the user for presentation at the first merchant for confirming purchase of the primary product. Once the user confirms purchase of the primary product, the computer system can generate a second promotional code or barcode—corresponding to the second reward—accessible to the user for presentation at the second merchant.

In the preceding example, when the user redeems this reward at the second merchant, the computer system can automatically reconcile distribution of the second reward between the first merchant and the second merchant based on characteristics of the user's basket. For example, the computer system can assign: a smaller proportion (e.g., thirty percent) of a reward value (e.g., a cost of the medium-sized beverage selected by the user at the second merchant) associated with the second reward to the first merchant from which the primary product was selected by the user (e.g., a merchant at which the transaction initiated); and a greater proportion (e.g., seventy percent) of the reward value to the second merchant, which may disproportionally benefit from selection of the primary product from the first merchant, such as due to increased traffic at the second merchant, increased brand lift, or an unexpected increase in revenue (e.g., if the user or the user's friend purchases additional products at the second merchant).

In another implementation, the computer system can: receive selection of a primary product sold by a first merchant from the user; and offer a general reward (e.g., “5% off your total purchase” or “$5 off your next purchase”) to the user for redemption at a set of merchants. For example, the computer system can offer the user a general reward that is redeemable at a set of merchants within a mall complex or within a particular chamber of commerce. Similarly, in this implementation, when the general reward is redeemed by the user, the computer system can automatically reconcile distribution of the general reward between the set of merchants, such as assigning: a first proportion of a reward value of the general reward to a first merchant from which the user selected a primary product (e.g., a merchant at which the transaction initiation); a second proportion of the reward value to a second merchant at which the user redeemed the general reward, the second proportion greater than the first proportion; and a third proportion of the reward value to other merchants—excluded from this transaction—in the set of merchants, the third proportion less than the first proportion.

### 15. Variation: Online Checkout Integration

In one variation, the computer system can interface with a checkout portal integrated within a webpage of the merchant. For example, a user may navigate—via her computing device—to a webpage corresponding to a particular merchant. In response to receiving selection of a primary product (e.g., via the user adding the primary product to her virtual shopping cart), from a set of products offered by the merchant at the webpage, from the user at her computing device, the computer system can automatically present the user (e.g., via a popup or notification on the webpage) with a reward package including a set of secondary products paired with corresponding rewards, based on the user's selection of the primary product. Additionally and/or alternatively, the computer system can withhold presentation of the reward package (e.g., while the user continues browsing products and/or selecting additional primary products to add to her basket) until the user navigates to her basket or “shopping cart” to view her selection of primary products. Before the user completes her purchase, the computer system can present the user with a reward package tailored to this particular user based on her selection of primary products. Thus, in this variation, the user can select and/or discard pairs of secondary products and rewards directly within the checkout portal and therefore automatically redeem these rewards upon completing her purchase within the checkout portal integrated into the website of the merchant.

The computer systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
in response to receiving selection of a primary product, from a set of products offered by a merchant, at a computing device associated with a user, populating a basket associated with the user with the primary product;
estimating a first predicted intent score for the user for purchase of a first secondary product, in the set of products, based on the primary product and historical purchases of products at the merchant;
calculating a first minimum reward value predicted to increase the first predicted intent score toward a first target intent score for the first secondary product;
in response to the first reward value falling below a first maximum reward value corresponding to the first secondary product:
selecting a first reward for pairing with the first secondary product based on the first minimum reward value; and
serving a first reward package to the user at the computing device, the first reward package comprising the first secondary product paired with the first reward; and
in response to receiving selection of the first secondary product at the computing device, populating the basket with the first secondary product paired with the first reward.

2. The method of claim 1, further comprising, in response to receiving selection of the first secondary product by the user:
estimating a second predicted intent score for the user for purchase of a second secondary product, in the set of products, based on the primary product, the first secondary product, and historical purchases of products at the merchant;
calculating a second minimum reward value predicted to increase the second predicted intent score toward a second target intent score for the second secondary product; and
in response to the second minimum reward value falling below a second maximum reward value for the second secondary product:
selecting a second reward for pairing with purchase of the second secondary product based on the second minimum reward value; and
serving a second reward package to the user at the computing device, the second reward package comprising the second secondary product paired with the second reward.

3. The method of claim 2, in response to receiving selection of the second secondary product from the user:
populating the basket with the second secondary product paired with the second reward; and
updating a total reward for the basket based on the first reward and the second reward.

4. The method of claim 1:
further comprising:
estimating a second predicted intent score for the user for purchase of a second secondary product, in the set of products, based on the primary product and historical purchases of products at the merchant;
calculating a second reward minimum value for the second secondary product predicted to increase the second predicted intent score toward a second target intent score for the second secondary product; and
in response to the second minimum reward value falling below a second maximum reward value for the second secondary product, selecting a second reward for pairing with purchase of the second secondary product based on the second minimum reward value; and
wherein serving the first reward package to the user, the first reward package comprising the first secondary product and the first reward, comprises serving the first reward package to the user, the first reward package comprising:
the first secondary product paired with the first reward; and
the second secondary product paired with the second reward.

5. The method of claim 4:
wherein estimating the second predicted intent score for the user for purchase of the second secondary product comprises estimating the second predicted intent score for the user for purchase of the second secondary product, the second predicted intent score less than the first predicted intent score; and
wherein calculating the second minimum reward value for the second secondary product comprises calculating the second reward value for the second secondary product, the second minimum reward value greater than the first minimum reward value.

6. The method of claim 1, wherein selecting the first reward for pairing with the first secondary product based on the first reward value comprises:
identifying a first subset of rewards, from a set of rewards offered by the merchant, corresponding to the first minimum reward value;
selecting the first reward from the first subset of rewards;
accessing a user profile, in a set of user profiles, associated with the user;
at the user profile, accessing a set of spent rewards, each spent reward in the set of spent rewards previously served to the user; and
in response to the set of spent rewards excluding the first reward, selecting the first reward for pairing with the first secondary product.

7. The method of claim 6, further comprising, in response to the set of spent rewards including the first reward:
accessing a first timestamp, stored at the user profile, associated with serving the user the first reward;
calculating a first duration based on the first timestamp and a current timestamp; and
in response to the first duration falling below a threshold duration, selecting a second reward, in replacement of the first reward, for pairing with the first secondary product based on the first minimum reward value.

8. The method of claim 7:
wherein selecting the first reward comprises selecting the first reward defining the first minimum reward value and a first reward format; and
wherein selecting the second reward, in replacement of the first reward, in response to the first duration falling below the threshold duration comprises selecting the second reward defining the first minimum reward value and a second reward format distinct from the first reward format.

9. The method of claim 1:
wherein calculating the first minimum reward value predicted to increase the first predicted intent score toward the first target intent score comprises:
accessing an intent model linking purchases of primary products to purchases of secondary products at the merchant;
estimating a first adjusted intent score comprising:
selecting a first reward value; and
estimating the first adjusted intent score for the first secondary product based on the intent model, the first primary product, the first secondary product, and the first reward value; and
in response to the first adjusted intent score falling within a threshold deviation of the first target intent score, storing the first reward value as the first minimum reward value.

10. The method of claim 9 further comprising, in response to the first adjusted intent score falling outside the threshold deviation of the first target intent score:
selecting a second reward value greater than the first reward value;
estimating a second adjusted intent score for the first secondary product based on the intent model, the first primary product, the first secondary product, and the second reward value, the second adjusted intent score greater than the first adjusted intent score; and
in response to the second adjusted intent score falling within the threshold deviation of the target intent score, storing the second reward value as the first minimum reward value.

11. The method of claim 9 wherein storing the first reward value as the first minimum reward value in response to the first adjusted intent score falling within the threshold deviation of the first target intent score further comprises, in response to the first adjusted intent score falling within the threshold deviation of the first target intent score:
selecting a third reward value less than the first reward value;
estimating a third adjusted intent score for the first secondary product based on the intent model, the primary product, the first secondary product, and the third reward value, the third intent score less than the first intent score; and
in response to the third intent score falling within threshold deviation of the first target intent score:
in response to the first deviation exceeding the third deviation, storing the third reward value as the first minimum reward value; and
in response to the third deviation exceeding the first deviation, storing the first reward value as the first minimum reward value.

12. The method of claim 1, wherein estimating the first predicted intent score for the first secondary product comprises:
extracting a set of basket characteristics from the basket;
accessing an intent model linking user purchases of primary products to purchases of secondary products at the merchant; and
calculating the first predicted intent score for the first secondary product based on the intent model and the set of basket characteristics.

13. The method of claim 1, further comprising, in response to receiving confirmation of the basket from the user:
generating a purchase code redeemable by the user at the merchant, the purchase code pairing the first reward with purchase of the primary product and the first secondary product; and
serving the purchase code to the user at the computing device.

14. The method of claim 13, further comprising:
in response to serving the purchase code to the user, initiating a timer for a first duration defined by the first reward; and
in response to expiration of the first timer prior to redemption of the purchase code at the first merchant by the user, invalidating the purchase code and the first reward.

15. The method of claim 14, further comprising:
in response to serving the purchase code to the user, initiating a notification timer for a second duration less than the first duration; and
in response to expiration of the notification timer:
generating a prompt to redeem the purchase code prior to expiration of the first duration; and
transmitting the prompt to the user.

16. The method of claim 1:
wherein estimating the first predicted intent score based on the primary product and historical purchases of products at the merchant comprises:
accessing a user profile, in a set of user profiles, corresponding to the user; and
accessing an intent model, stored in the user profile, linking purchases of primary products to purchases of secondary products for the user;
further comprising, in response to receiving selection of the first secondary product from the user:
storing the first primary product, the first secondary product, and the first reward in a first session container at the user profile; and
updating the intent model based on the first session container.

17. A method comprising:
in response to receiving selection of a primary product at a computing device associated with a user, the primary product in a set of products offered by a merchant, populating a basket associated with the user with the primary product;
extracting a first set of basket characteristics for the basket comprising a product type of the primary product and a first value assigned to the primary product;
accessing an intent model linking basket characteristics with purchases of products at the merchant;
characterizing a first predicted intent of the user for selection of a first secondary product, in the set of products, based on the set of basket characteristics and the intent model;
in response to the first predicted intent exceeding a threshold intent:
calculating a first reward for pairing with the first secondary product based on the first predicted intent of the user for the first secondary product; and
serving a first reward package to the user at the computing device, the first reward package comprising the first secondary product paired with the first reward; and
in response to receiving selection of the first secondary product from the user, at the computing device, populating the basket with the first secondary product paired with the first reward.

18. The method of claim 17:
wherein characterizing the first predicted intent comprises estimating a first predicted intent score for the user for selection of the first secondary product based on the first set of basket characteristics and the intent model; and
wherein calculating a first reward for pairing with the first secondary product based on the first predicted intent of the user comprises:
calculating a first predicted value for the basket based on the first value, a second value assigned to the first secondary product, and the first predicted intent score; and
calculating a reward value configured to increase the first predicted value of the basket.

19. The method of claim 17, wherein calculating the first reward for pairing with the first secondary product based on the first predicted intent of the user comprises calculating the first reward for pairing with the first secondary product inversely proportional to the first predicted intent of the user.

20. The method of claim 17:
wherein characterizing the first predicted intent of the user for selection of the first secondary product based on the set of basket characteristics and the intent model comprises:
calculating a first intent score for the first secondary product when paired with a first reward value of null;
calculating a second intent score for the first secondary product when paired with a second reward value, greater than the first reward value;
calculating third intent score for the first secondary product when paired with a third reward value, greater than the second reward value; and
characterizing an intent profile for the user for the first secondary product based on the first intent score and the first reward value, the second intent score and the second reward value, and the third intent score and the third reward value; and
wherein calculating the first reward for pairing with the first secondary product based on the first predicted intent comprises:
estimating a target reward value based on the intent profile; and
selecting the first reward based on the target reward value.
